(19) United States
(12) Patent Application Publication
(10) Pub. No.: US 2017/0331428 A1
(43) Pub. Date: Nov. 16, 2017

(54) SOLAR MODULE COVERS

(71) Applicant: Vivint Solar, Inc., Lehi, UT (US)

(72) Inventors: Willard S. MacDonald, Sebastopol, CA (US); Daniel Rapp, Lehi, UT (US); Paul Hernday, Santa Rosa, CA (US)

(21) Appl. No.: 15/594,329

(22) Filed: May 12, 2017

Related U.S. Application Data
(60) Provisional application No. 62/335,245, filed on May 12, 2016.

(51) Int. Cl. H02S 99/00; H02S 30/10; H02S 20/23

(52) U.S. Cl. CPC H02S 99/00; H02S 20/23; H02S 30/10

(57) ABSTRACT

The present disclosure is directed to solar module covers. A device may include a first surface and a second, opposite surface configured to be positioned proximate at least one solar module and contact at least one of a frame of the at least one solar module and a roof. The device may be sufficiently rigid to distribute at least some of an external force applied to the first surface away from a laminate of the at least one solar module.

### CROSS-REFERENCE TO RELATED APPLICATION

A claim for benefit of priority to the May 12, 2016 filing date of the U.S. Patent Provisional Application No. 62/335,245, titled “SOLAR MODULE COVERS” (the '245 Provisional Application), is hereby made pursuant to 35 U.S.C. §119(e). The entire disclosure of the '245 Provisional Application is hereby incorporated herein.

### TECHNICAL FIELD

This disclosure relates generally to solar module covers and, more specifically, to devices configured to be positioned proximate one or more solar modules.

### BRIEF SUMMARY

In one specific embodiment, a device may include a first surface and a second, opposite surface configured to be positioned proximate one or more solar modules. The device may be further configured to contact a frame of the one or more solar modules, a roof, or both. The device may be sufficiently rigid to distribute at least some of an external force applied to the first surface away from a laminate of the one or more solar modules.

In some embodiments, the device may include, for example only, metal, wood, fiberglass, carbon fiber, or any combination thereof. Further, the first surface may include a high friction material, such as, rubber, foam, grit, or any combination thereof.

Further, according to various embodiments, the device may include an attachment device configured to secure the device to the one or more solar modules, the roof, or both. For example, the attachment device may include a hook. The device, in some embodiments, may be configured to be rolled-up or folded, which may simplify transportation of the device (e.g., to/from a worksite, on/off of a roof, etc.).

The device may be configured to contact at least one ridge of at least one frame of the one or more solar modules. In one embodiment, the second surface may contact the at least one ridge. Further, in one embodiment, the second surface may include one or more structural members that contact the at least one ridge. In yet another embodiment, the device may include one or more feet that extend from the second surface and contact the roof, thus preventing any force from being applied to a solar module or a solar module frame.

In various embodiments, the device may include an opening, which may provide access to one or more solar modules positioned under and/or near the device. The opening, which may comprise a hatch opening, may include a door and one or more hinges. In yet another embodiment, the device may be configured to provide a level surface. More specifically, for example, the device may include one or more hinged sections that form the level surface. The configuration of the one or more hinged sections may be adjusted to accommodate different slopes, thus ensuring that a flat surface may be provided regardless of a pitch of a solar module array.

In another specific embodiment, a system may include one or more solar modules positioned on an external surface of a roof. The system may further include a device coupled to at least one of the roof and the one or more solar modules and configured to receive a force applied thereto and distribute at least some of the force away from a laminate of the one or more solar modules.

According to another embodiment, a device includes a substantially rigid material and is configured to be positioned proximate at least one solar module, which is coupled to a roof. The device is configured to prevent a force applied thereto from reaching a laminate of the at least one solar module.

Other aspects, as well as features and advantages of various aspects, of the present disclosure will become apparent to those of skill in the art through consideration of the ensuing description, the accompanying drawings and the appended claims.

### BRIEF DESCRIPTION OF THE DRAWINGS

FIG. 1 is a plot depicting degradation of various solar module parameters as a function of thermal cycles;

FIG. 2 illustrates a device positioned proximate a solar module array coupled to a roof, according to at least one embodiment of the present disclosure;

FIG. 3 depicts an example device and a solar module, in accordance with an embodiment of the present disclosure;

FIG. 4 depicts an example device including structural members, in accordance with at least one embodiment of the present disclosure;

FIG. 5 is another illustration of an example device including structural members, according to at least one embodiment of the present disclosure;

FIG. 6 depicts an example device secured to a solar module via an attachment device, according to at least one embodiment of the present disclosure;

FIG. 7 illustrates an example device including a plurality of hinged sections, according to at least one embodiment of the present disclosure;

FIG. 8A illustrates an example device including hinge sections having cavities and structural members, in accordance with at least one embodiment of the present disclosure;

FIG. 8B is a cross-sectional illustration of an example device including cavities and structural members, in accordance with at least one embodiment of the present disclosure;

FIG. 8C illustrates two sections of an example device folded together, according to at least one embodiment of the present disclosure;

FIG. 9 depicts an example device including feet configured to contact a roof, according to at least one embodiment of the present disclosure;

FIG. 10 illustrates an example device including an opening, in accordance with at least one embodiment of the present disclosure; and

FIG. 11 illustrates an example device configured to provide a flat surface, according to at least one embodiment of the present disclosure.

### DETAILED DESCRIPTION

Referring in general to the accompanying drawings, various embodiments of the present disclosure are illustrated to show the structure for a carrier device. Common elements of the illustrated embodiments are designated with like numerals. It should be understood that the figures presented are not meant to be illustrative of actual views of any particular portion of the actual device structure, but are merely schematic representations which are employed to more clearly and fully depict embodiments of the disclosure.

The following provides a more detailed description of the present disclosure and various representative embodiments thereof. In this description, functions may be shown in block diagram form in order not to obscure the present disclosure in unnecessary detail. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Solar photovoltaic (PV) cells use light energy (photons) from the sun to generate electricity through a photovoltaic effect. A PV solar module includes PV cells mounted behind glass and typically includes a frame at least partially surrounding the edges of the cells and glass. As will be appreciated, the glass and/or laminate (commonly referred to herein as “laminate”) is designed to span the distances between the frame sections. A PV system, which includes one or more solar modules installed on a roof, and various other electrical components, may be used to generate and supply electricity in utility, commercial and residential applications.

During installation, or repair, of a PV system, an installer's weight may be applied to one or more solar modules, which are positioned on a roof. For example, while working on electrical wiring (e.g., in a junction box), an installer may walk on, stand on, sit on, and/or kneel on a solar module. A top surface of a solar module is typically glass, and a pitch for residential roofs is typically in the range of 10 to 45 degrees. Thus, stepping, standing, sitting, and/or kneeling on a surface of a solar module on a roof may be dangerous and could lead to slipping and injury, especially if there is moisture on the solar module (e.g., from rain or dew). It is noted that the term “installer” is not limited to a person installing a PV system. Rather, “installer” as used herein may refer to a device user or anyone on a roof (e.g., a repair man, roofer, etc.).

The weight of a user (e.g., an installer) on a solar module may cause micro-cracking of the PV cells due to the deflection of the solar module. Micro-cracking may result in long-term degradation of the PV cells as temperature cycling causes the cracks to get larger and larger until metallization layers are cracked, resulting in the electrical isolation of sections of the cells. The dimensions of a typical 60 cell solar module are approximately 1.5×1 meter. When a force is applied to a laminate (e.g., via an installer's weight), deflection may occur that may lead to micro cracks in the cell.

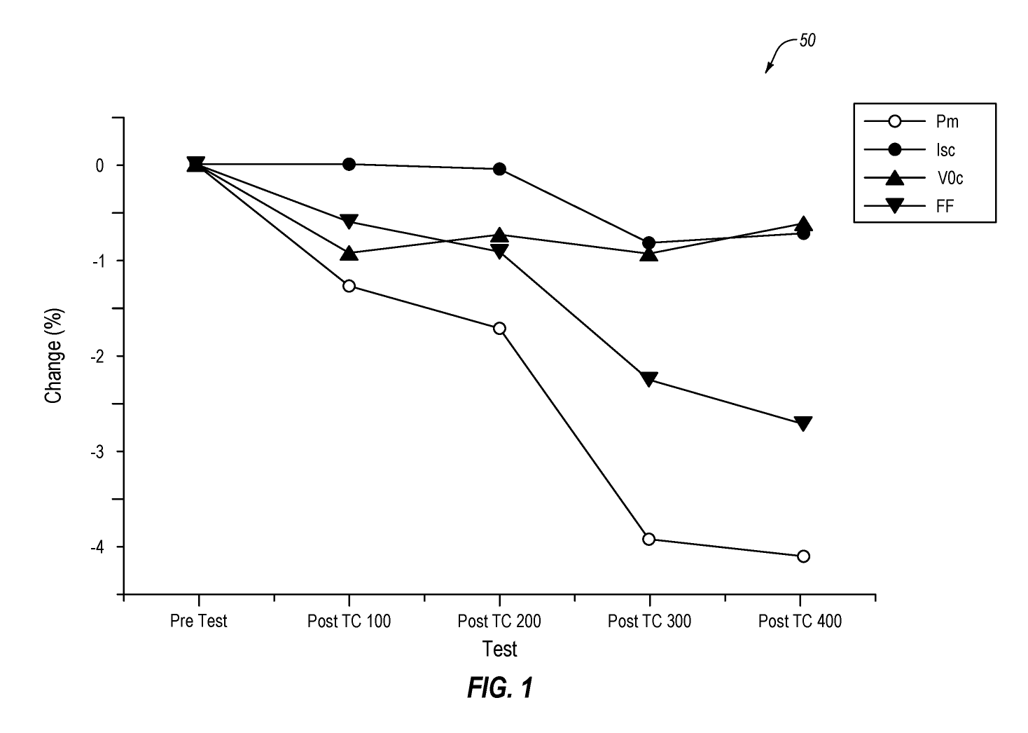

FIG. 1 is a plot 50 illustrating degradation of various solar module parameters (i.e., maximum power (Pm), short circuit current (Isc), open circuit voltage (Voc), and fill factor (FF)) as a function of the number of thermal cycles (i.e., after each batch of 100 thermal cycles). Khatri et. al. “Study on long term reliability of photo-voltaic modules and analysis of power degradation using accelerated aging tests and electroluminescence technique.” Energy Procedia 8 (2011) 396-401. Thus, in addition to being dangerous, applying a force to a solar module laminate (e.g., via walking on, standing on, sitting on, and/or kneeling on) may increase long term PV performance degradation.

Various embodiments disclosed herein are related to devices (also referred to herein as a “cover” or a “cover device”) configured to enable an installer to put his or her weight on (e.g., via walking, standing on, kneeling on, sitting on, etc.) one or more solar modules while reducing the potential for injury and/or micro-cracking of PV cells. In one specific embodiment, the device may include a substantially ridged (i.e., does not have excessive flex under load), flat material. The device may be positioned proximate (e.g., over) at least a portion of a solar module array to provide a surface to, for example, sit on, walk on, stand on, kneel on, etc. Some embodiments disclosed herein may enhance safety for a user and/or decrease the likelihood of damage to the one or more solar modules. It is noted that the device may not be a substitute for fall protection, and a harness, a safety line, and/or an anchor may be used to increase safety.

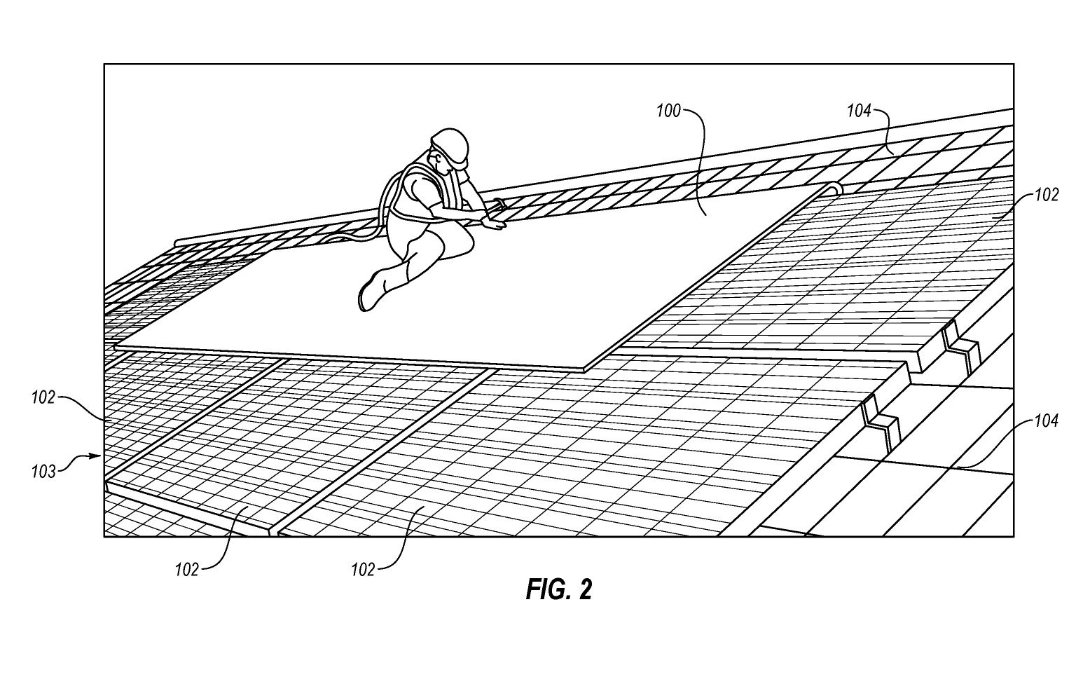

FIG. 2 illustrates a device 100 positioned over a plurality of solar modules 102 of a solar module array 103, which is positioned on a roof 104. Although device 100 is illustrated in FIG. 1 as sized to span more than one solar module 102, device 100 may be any suitable size to span at least a portion of one or more solar modules 102.

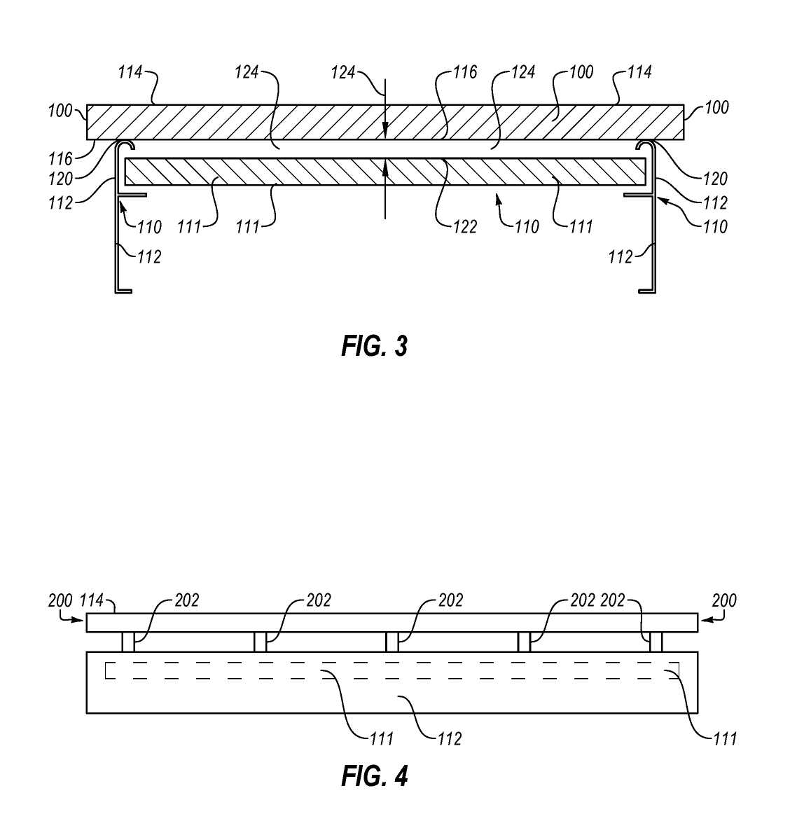

In some embodiments, device 100 may be sized to at least span a distance between at least two parallel frame sections of a solar module. FIG. 3 depicts a solar module 110 including a laminate 111 and a frame 112. FIG. 3 further includes device 100 including a surface 114 and a surface 116. As illustrated in FIG. 3, solar module frame 112 may include ridges 120 that extend beyond a surface (e.g., a top surface) 122 of solar module laminate 111. In one embodiment, device 100 may span the distance between ridges 120, as shown in FIG. 3, and one or more ridges 120 may support device 100, resulting in a gap 124 between device 100 and a laminate 111 of solar module 110. This may reduce, and possibly eliminate, a force (e.g., from an installer's weight) applied to laminate 111 and its cells. Device 100 may comprise of any suitable material, such as a material that minimizes deflection when a force is applied to surface 114. In one embodiment, device 100 may comprise of a material that is sufficiently rigid to maintain a gap (i.e., air gap) 124 (i.e., while supporting the weight of one or more installers). As more specific, non-limiting examples, device 100 may comprise metal, wood, fiberglass, carbon fiber, etc.

Surface 114 may comprise a high friction material to provide additional grip for an installer. For example, surface 114 may include rubber, foam, grit, a combination thereof, or any other high friction material.

In some embodiments, a cover device (e.g., device 100) may be configured to fold (e.g., to aid in transportation) (e.g., to/from a job site, to/from a structure, on/off of a roof, etc.). The cover device may include one or more hinges. The one or more hinges may include separate mating sections and, for example, a pin like a barrel hinge, a door hinge, a cabinet hinge, a piano hinge, etc. As another example, the one or more hinges may include a flexible material, such as fabric, polymer, leather, etc. As a non-limiting example, if the cover device is relatively large (e.g., 4 meters by 1.5 meters), the one or more hinges may enable the cover device to be folded up to a more manageable size (e.g., 1 meter by 1.5 meters).

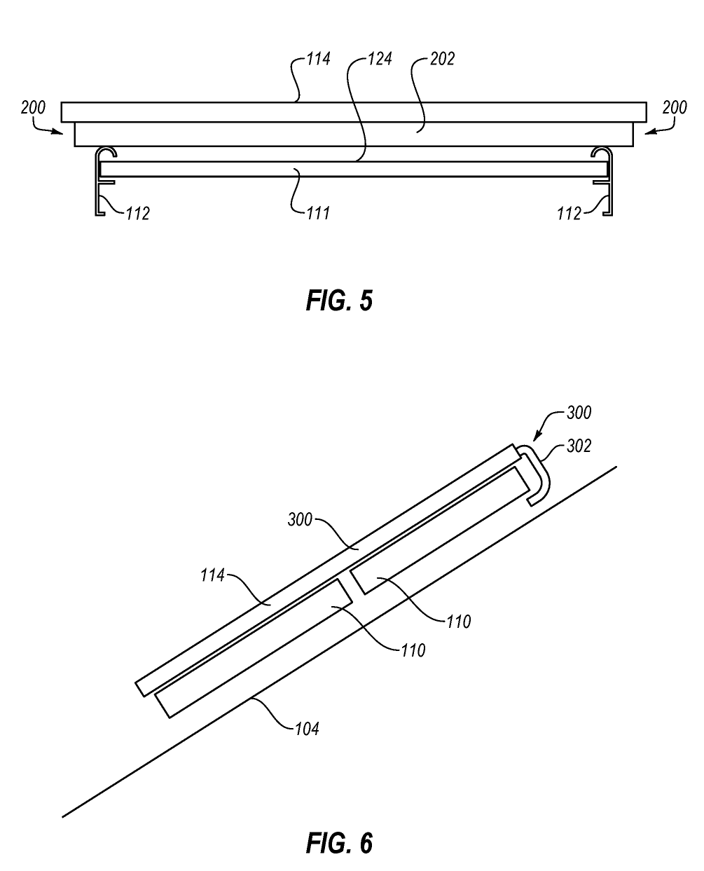

A cover device, which includes material that is sufficiently ridged to minimize deflection and maintain a gap (e.g., gap 124; see FIG. 3) between it and a laminate, may be heavy and/or expensive. In another embodiment, the cover device may include one or more structural members that enable the cover device to span the necessary distances while being light and cost effective. FIG. 4 depicts a device 200 including structural members 202. Structural members 202 may increase the stiffness of device 200 by adding relatively inelastic material in zones of maximum tensions and compression without adding significant weight or cost, similar to the functionality of an I-Beam. FIG. 4 is a first side view of device 200, and FIG. 5 is a second side view (i.e., rotated 90 degrees with respect to the view of FIG. 4) of device 200. As illustrated in FIG. 5, structural member 202 of device 200 contacts solar module frame 112, and gap 124 exists between structural member 202 and laminate 111.

According to some embodiments, a cover device may be configured to prevent the cover device from sliding down a slope of one or more solar modules and/or a roof. For example, as illustrated in FIG. 6, a device 300 includes one or more attachment devices 302 configured to couple to one or more solar modules 110. As a non-limiting example, attachment device 302 may include a hook. Although one or more attachment devices 302 are illustrated as coupling to solar module 110, the present disclosure is not so limited. Rather, one or more attachment devices 302 may be configured to couple to any structure (e.g., roof 104) to secure cover device 300 and prevent cover device 300 from sliding down a slope. It is noted that, to enhance clarity, solar module racking is not illustrated in FIG. 6.

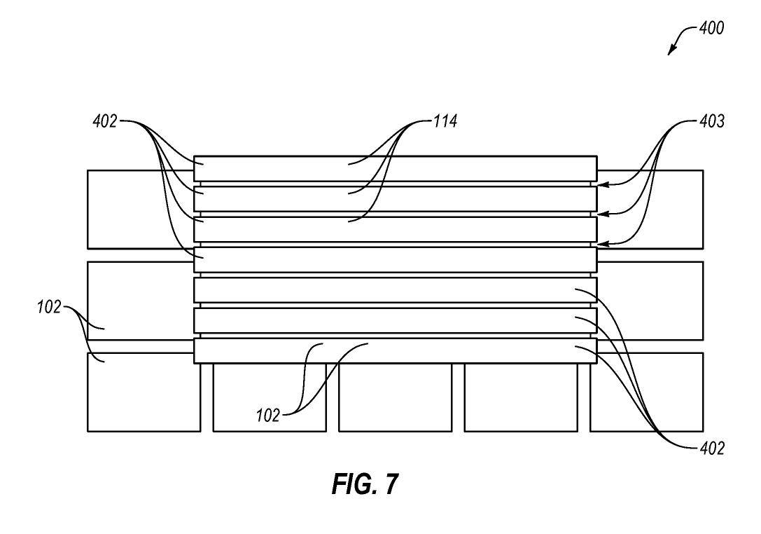

Sections of a cover device may be wider than the dimensions of a solar module, or may be narrower than one or more dimensions of a solar module. In one embodiment illustrated in FIG. 7, a cover device 400 includes a plurality of sections 402 with hinges 403 therebetween. In this embodiment, cover device 400 may be configured to “roll up” (e.g., to simplify transportation of device 400). In another example, sections 402 may be oriented top-to-bottom rather than side-to-side. Stated another way, device 400 may be rotated 90 degrees relative to the illustration shown in FIG. 7.

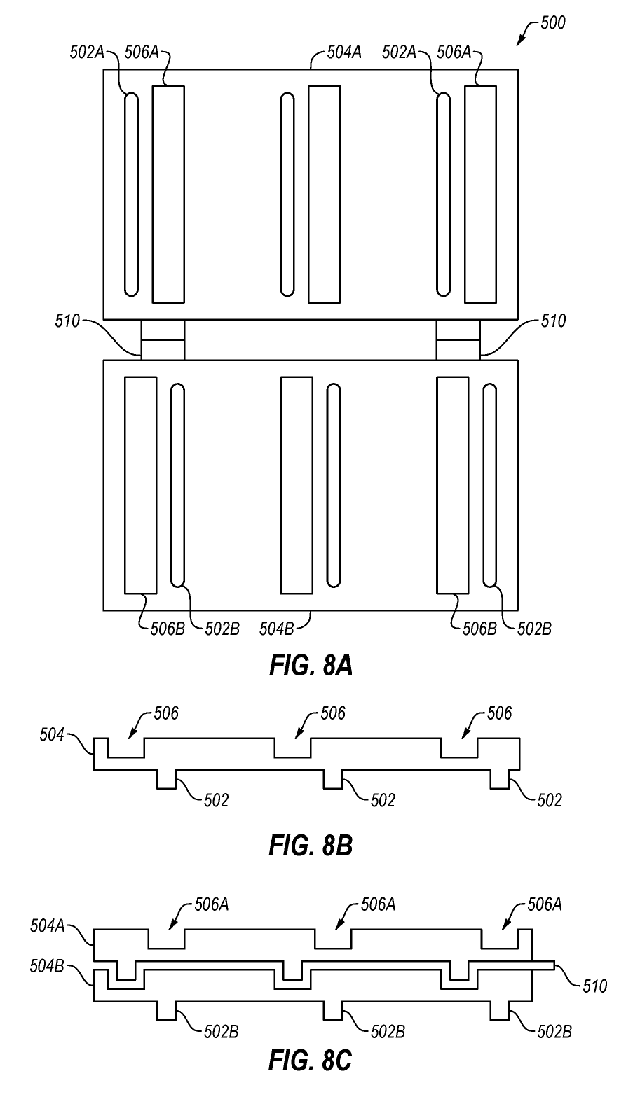

A cover device with hinged sections, each with structural members, may be bulky when folded or rolled-up (e.g., because the structural members may leave significant empty space inside the folded or rolled-up device). According to another embodiment, two or more sections of a cover device may be configured to interlock (e.g., to minimize bulkiness for transportation). More specifically, for example, a cover device may be configured to enable structural members of a first section to fit into cavities or cutouts in an adjacent, second section, which is folded together with the first section. For example, FIGS. 8A-8C depict another embodiment of a device 500 configured to enable structural members 502A of first section 504A to fit into cavities or cutouts 506B in an adjacent, second section 504B that is folded together with first section 504A. Specifically, FIG. 8A depicts two sections 504A/504B of a device 500 in an unfolded state (i.e., a top or bottom view) with hinges 510, cavities 506, and structural members 502, and FIG. 8C depicts two sections of device 500 in a folded state (i.e., a side-view). Further, FIG. 8B is a cross-sectional depiction of a single section 504 including structural members 502 and cavities 506.

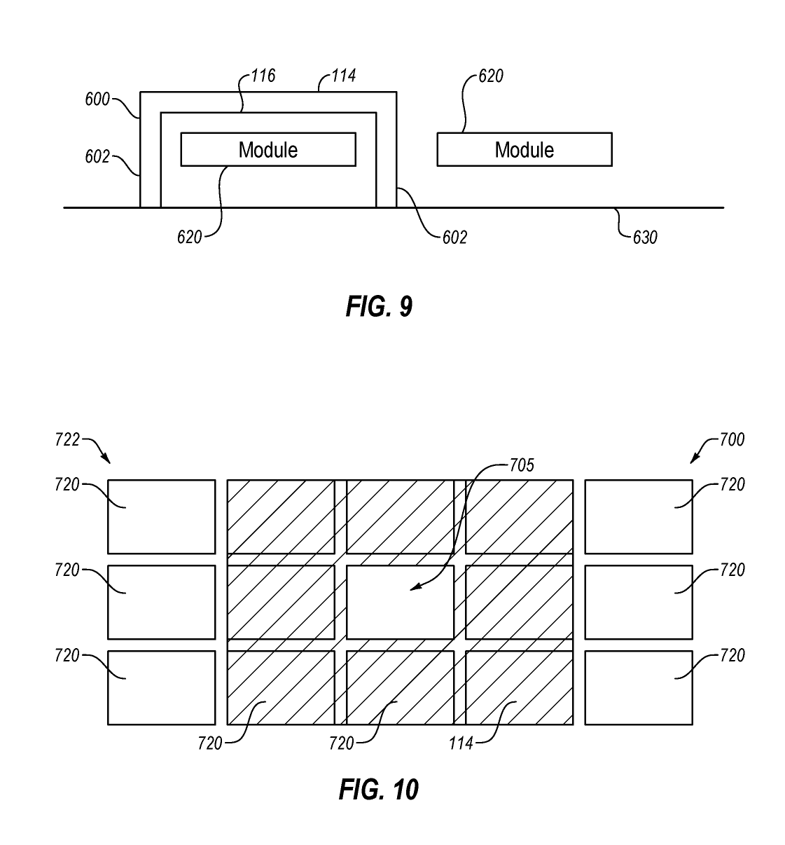

In various embodiments described above, a cover device may be positioned on one or more solar module frames. In other embodiments, a cover device may include one or more feet configured to be positioned on a roof (e.g., directly on the roof), thus, eliminating any forces on one or more solar modules or frames. According to some embodiments, the one or more feet may extend past one or more solar modules (e.g., in between solar modules or around an outer edge of a solar array). Some solar module racking systems may include an approximate 1″ gap between adjacent solar modules, which may allow the feet to be positioned in between solar modules to contact a roof. For example, as shown in FIG. 9, a cover device 600 includes surface 114, surface 116, and feet 602 that may extend past one or more solar modules 620 and contact a roof 630. It is noted that, to enhance clarity, solar module racking is not illustrated in FIG. 9.

In various solar module arrays (e.g., relatively large solar module arrays), it may be challenging to access one or more solar modules (e.g., in the middle of the array) without putting weight on (e.g., via walking, crawling, kneeling, or sitting) one or more surrounding solar modules. In another embodiment, a cover device may be configured to enable access to one or more solar modules (e.g., underneath the cover device) via an opening (e.g., a hatch opening). The opening may include an access door with, for example, one or more hinges. For example, FIG. 10 illustrates a cover device 700 positioned proximate a plurality of solar modules 720 of a solar module array 722. As depicted in FIG. 10, cover device 700 includes an opening 705, which may enable access to one or more solar modules 720. It is noted that, although not illustrated in FIG. 10, cover device 700 may include an access door coupled to cover device 700 via one or more hinges. The access door may be opened to provide opening 705.

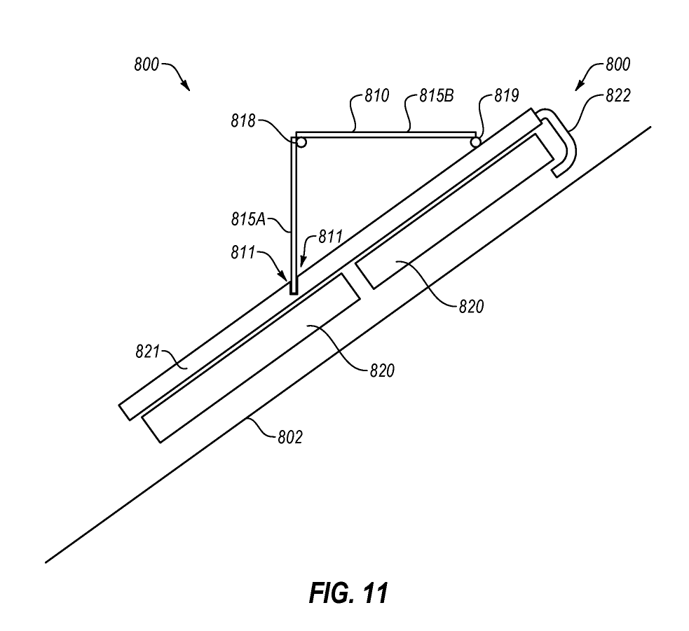

In various embodiments described above, a surface of a cover device is configured to be substantially parallel to a sloped surface (e.g., a top surface) of one or more solar modules coupled to a roof. As will be appreciated, when working on a solar installation, it may be tiring for the technicians to stand, walk, and/or sit on a sloped surface. According to another embodiment of the disclosure, a cover device may be configured to provide one or more level surfaces (e.g., proximate a solar module array). For example, as illustrated in FIG. 11, a cover device 800 may include sections 815A and 815B configured to provide a flat surface 810 while being positioned proximate one or more solar modules 820 coupled to roof 802, wherein solar modules 820 and roof 802 are sloped. More specifically, cover device 800 includes sections 815A and 815B coupled together via hinge 818 to form flat surface 810 (also referred to herein as a “step”). Cover device 800 may include a portion 821, which is substantially parallel to roof 802 and a surface of solar modules 820. As illustrated, an end of section 815A may be configured to fit into a groove 811 of a portion 821 of cover device 800. It is noted that a variety of grooves (not shown in FIG. 11) may be included to accommodate different pitches so that a flat surface may be achieved regardless of the pitch of roof 802. Cover device 800 further includes a hinge 819 for coupling section 815B to portion 821 of cover device 800, and an attachment device 822 for securing cover device 800 to one or more solar modules 820. It is noted that, to enhance clarity, solar module racking is not illustrated in FIG. 11.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed:

1. A device, comprising:
a first surface; and
a second, opposite surface configured to be positioned proximate at least one solar module and contact at least one of a frame of the at least one solar module and a roof;
wherein the device is sufficiently rigid to distribute at least some of an external force applied to the first surface away from a laminate of the at least one solar module.

2. The device of claim 1, the first surface comprising at least one of rubber, a foam material, and a grit material.

3. The device of claim 1, wherein upon being positioned proximate to the at least one solar module, a gap exists between the second surface and a laminate of the at least one solar module.

4. The device of claim 1, further comprising an attachment device configured to secure the device to at least one of the at least one solar module and the roof.

5. The device of claim 1, wherein the second, opposite surface includes one or more structural members configured to contact at least a portion of the at least one solar module.

6. The device of claim 5, wherein the one or more structural members are configured to contact at least one ridge of at least one solar module frame.

7. The device of claim 1, wherein the second surface is configured to contact at least one ridge of at least one solar module frame.

8. The device of claim 1, further comprising a plurality of foldable sections, wherein each section of the plurality of foldable sections comprises the first and second surfaces and is coupled to an adjacent section via at least one hinge.

9. The device of claim 8, wherein at least one section of the plurality of foldable sections includes at least one cavity configured to receive a structural member of an adjacent section upon the at least one section and the adjacent section being folded together.

10. The device of claim 1, further comprising one or more feet extending from the second surface and configured to contact the roof.

11. The device of claim 1, further comprising an opening extending through the first and second surfaces and configured to provide access to one or more solar modules proximate thereto.

12. The device of claim 11, further comprising a door coupled to at least one of the first and second surfaces via at least one hinge and configured to provide the opening while in an open position.

13. A system, comprising:
one or more solar modules positioned on an external surface of a roof; and
a cover device coupled to at least one of the roof and the one or more solar modules and configured to receive a force applied thereto and distribute at least some of the force away from a laminate of the one or more solar modules.

14. The system of claim 13, wherein the cover device comprises:
a first surface configured to receive the force; and
a second, opposite surface configured to be positioned proximate at least one solar module of the one or more solar modules and contact at least one of a frame of the at least one solar module and the roof.

15. The system of claim 14, the first surface comprising at least one of rubber, a foam material, and a grit material.

16. The system of claim 14, wherein the second, opposite surface includes one or more structural members configured to contact at least a portion of the at least one solar module.

17. The system of claim 13, wherein the cover device comprises at least two sections coupled together via at least one hinge, the at least two sections being foldable via the at least one hinge.

18. The system of claim 13, wherein the cover device further comprises one or more feet configured to contact the roof.

19. The system of claim 13, wherein the cover device is configured to contact at least one ridge of at least one solar module frame.

20. A device, comprising a substantially rigid material and configured to be positioned proximate at least one solar module coupled to a roof and prevent a force applied thereto from reaching a laminate of the at least one solar module.
